(19) United States
(12) Patent Application Publication
(10) Pub. No.: US 2011/0241846 A1
(43) Pub. Date: Oct. 6, 2011

(54) Technique For Effective Communications With Mobile Sensors In A Sensor System

(75) Inventors: Mauricio Cortes, Scotch Plains, NJ (US); Thomas John Janiszewski, Andover, NJ (US); Jairo O. Esteban, Freehold, NJ (US)

(73) Assignee: Alcatel-Lucent USA Inc., Murray Hill, NJ (US)

(21) Appl. No.: 12/749,780

(22) Filed: Mar. 30, 2010

(51) Int. Cl. G06K 7/01

(52) U.S. Cl. 340/10.51

(57) ABSTRACT

In a sensor system, an edge element receives data from at least one mobile sensor, and sends the data which may be preprocessed by the edge element to a server for further processing. The edge element may communicate to the mobile sensor to change a value of a run-time parameter in the mobile sensor to affect its operation. The edge element may also cause the mobile sensor to upgrade its firmware. When the mobile sensor is about to leave communication coverage of the edge element, the latter may initiate a peer-to-peer handover of the control and administration of the mobile sensor to another edge element in the sensor system.

### FIELD OF THE INVENTION

The invention relates to a communication technique and, more particularly, to a technique for communications between mobile sensors and edge elements in a sensor system.

### BACKGROUND OF THE INVENTION

This section introduces aspects that may help facilitate a better understanding of the invention. Accordingly, the statements of this section are to be read in this light and are not to be understood as admissions about what is prior art or what is not prior art.

In a sensor system, mobile sensors, e.g., mobile tags, pingers, etc., may gather information, and transmit the same for reception by edge elements of the system, e.g., tag readers, radio frequency identification (RFID) readers, etc., for processing the information. For example, a mobile tag which may be attached to equipment transmits reports of its current location to which a nearby tag reader is receptive, which may in turn inform the system of the latest location of the equipment. In general, mobile sensors may actively transmit infrared, ultrasound, bluetooth or other RF signals which may contain their identification (ID), environmental metrics such as temperature measures, humidity measures, etc. For example, a typical sensor system in a hospital has tens of thousands of mobile sensors reporting patient and environmental metrics continuously. Mobile sensors may also act as a transport for carrying information, previously written thereon by an edge element, to another edge element in the same system which reads the information therefrom.

Edge elements of a sensor system, which provide for mobile sensors access to the processing portion of the system, not only can store/forward information received from the mobile sensors, but also clean, filter and aggregate the information before it is sent to an appropriate serves in the system for further processing.

### BRIEF SUMMARY

With the advent of integrated circuit (IC) and battery technologies, the mobile sensors whose principal components are IC chips consume much less power and run on batteries having a much longer lifetime than before. Although the mobile sensors are built to last for many years, their firmware may need to be upgraded and program parameters be modified from time to time during their lifetime employment. In accordance with one embodiment of the invention, an edge element of a sensor system stores therein an identification of at least one mobile sensor, and information concerning a parameter in association with the identification of the mobile sensor. The edge element receives data from the mobile sensor operating based on a first value of the parameter in the mobile sensor, and sends information, derivable from the data, to a server for processing the information. The edge element may cause the first value of the parameter in the mobile sensor to be changed to a second value, thereby affecting an operation of the mobile sensor.

In accordance with another embodiment of the invention, an edge element of a sensor system stores therein an identification of at least one mobile sensor and, in association with the identification, information concerning selected software executable on the mobile sensor. The edge element receives data from the mobile sensor having the selected software therein. The edge element may receive from a server a request for upgrading the selected software, and code for upgrading the selected software. In response to such a request, the edge element retrieves the identification of the mobile sensor, and sends the received code to the mobile sensor identified by the retrieved identification for upgrading the selected software therein.

In accordance with yet another embodiment of the invention, a certain edge element of a sensor system receives data from a mobile sensor associated therewith. When the certain edge element determines that the mobile sensor is about to leave communication coverage thereof, it communicates to other edge elements in the sensor system an identification of the mobile sensor. After the certain edge element receives from a selected one of the other edge elements information concerning detection of the mobile sensor within communication coverage of the selected edge element, the certain edge element dissociates the mobile sensor therefrom.

### BRIEF DESCRIPTION OF THE DRAWINGS

FIG. 1 is a block diagram of a sensor system according to one embodiment of the invention;

FIG. 2 is a block diagram of an edge element which may be used in the system of FIG. 1;

FIG. 3 illustrates a profile of a mobile sensor according to one embodiment of the invention;

FIG. 4 is a block diagram of a mobile sensor which may be used in the system of FIG. 1;

FIG. 5 is a block diagram of a network server which may be used in the system of FIG. 1; and

FIGS. 6A, 6B, 6C and 6D are flow charts illustrating individual processes performed by an edge element according to various embodiments of the invention.

### DETAILED DESCRIPTION

In one embodiment in accordance with the invention, mobile sensors in a sensor system, e.g., mobile tags, pingers or other wireless devices, are battery powered devices and capable of duplex communications. With the advent of integrated circuit (IC) and battery technologies, the mobile sensors whose principal components are IC chips consume much less power and run on batteries having a much longer lifetime than before. Although the mobile sensors are built to last for many years, their firmware may need to be upgraded and program parameters be modified from time to time during their lifetime employment. A traditional method of achieving such an upgrade and modification is by physically taking the mobile sensors out of service, and collecting and re-configuring them en masse at a central location. However, this traditional method may sometimes prove to be ineffective or even impractical.

For example, in a hospital where tens of thousands of mobile sensors are deployed in a sensor system to measure and report patient and environmental data continuously, collection, reconfiguration and redeployment of a large number of mobile sensors would undesirably stifle the continuous operation of the system. In addition, for those mobile sensors used in certain environments, e.g., underwater, underground, war zones, extreme climatic conditions, or extraterrestrial sensor systems, once they are deployed into such environments, it is impractical to collect and redeploy them.

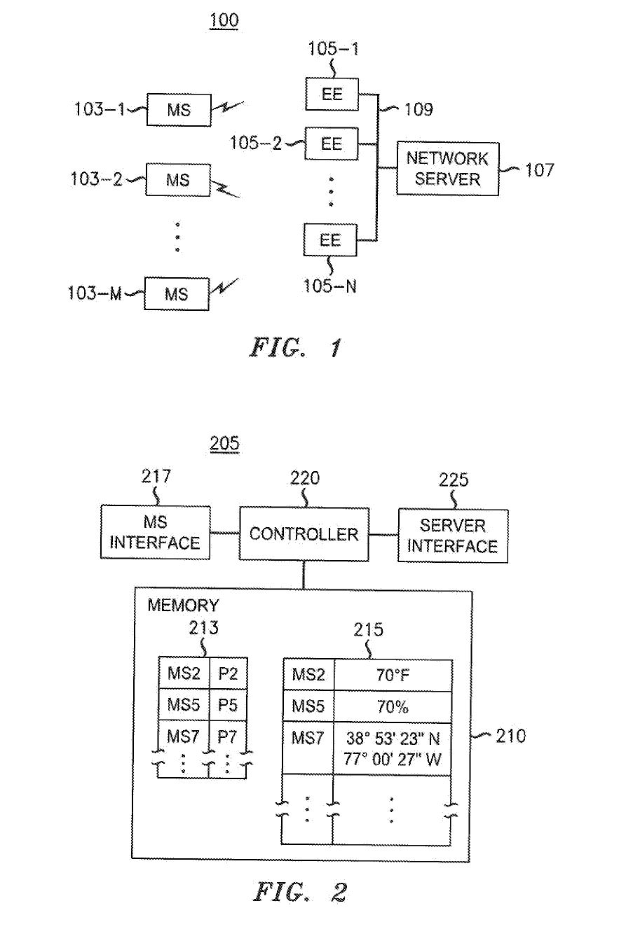

The invention solves the above-identified problems by remotely reconfiguring mobile sensors in real time to dynamically change their preconfigured mode of operation, thereby altering the way the mobile sensors respond to edge elements in the same sensor system. FIG. 1 illustrates a sensor system 100 embodying the principles of the invention. In sensor system 100, mobile sensors (MSs) 103-1 through 103-M are capable of communicating with edge elements (EEs) 105-1 through 105-N over the air, where M and N are integers. MSs 103 transmit signals (e.g., RF signals) which may contain their identification (ID), location information, environmental metrics such as temperature measures, humidity measures, etc., depending on their specific configuration. Signals from a transmitting MS are receivable by an EE in the proximity of the MS, which may aggregate, clean and filter the data contained in such signals. The EE may forward to network server 107 the resulting data for further processing via a local area network (LAN) 109, e.g., an Ethernet, which connects EEs 105 to network server 107. In another embodiment where EEs 105 and MSs 103 are configured in a network according to the well known Wi-Fi standards, EEs 105 are Wi-Fi access points through which data contained in Wi-Fi signals from MSs 103 is selectively forwarded to network server 107.

Importantly, in system 100 MSs 103 not only transmit data but also listen to EEs 105 in their proximity and receive therefrom signals containing run-time parameters, which may affect the current operations of MSs 103, and may also alter the way MSs 103 communicate with EEs 105. For example, these parameters may specify which MSs should report information, when to report such information, what information to report, which data format to use, what conditions under which to send reports, what power and other communication-related parameters are used to communicate with EEs 105.

In addition, the signals received by MSs 103 may contain program code for upgrading firmware of the ME 103. To manage MSs 103 remotely and effectively, EEs 105 are coordinated such that no two EEs contact MSs with the same or contradictory directives. In one embodiment, EEs can upgrade firmware of MSs by broadcasting through a broadcast channel a new version of firmware code, with the corresponding firmware version ID including a version number, to all MSs which are close enough to listen to the broadcast. On hearing the broadcast, an MS may check whether the firmware in question is relevant to its operation. If so, the MS may go on to check the version number of the firmware installed with the broadcast version number. If it determines that the broadcast version number is higher than the installed version number, it initiates an upgrade of the firmware in question.

In this particular illustrative embodiment, each EE 105 is in possession of profiles of the MSs under its control and within its communication coverage or reach. The profile information comes from network server 107 in a manner described below, which enables the EE 105 to communicate effectively with the MSs individually. FIG. 2 illustrates EE 205, which can be used as each instance of EE 105 in FIG. 1. EE 205 in this instance has in its memory 210 registration table 213 which contains identifications (IDs) of the MSs registered therewith in its communication coverage. The process for registering an MS with a particular EE is fully described below. As shown in table 213, the IDs of the registered MSs are MS2, MS5, MS7 . . . . Table 213 also contains profiles P2, P5, P7 . . . of the respective registered MSs.

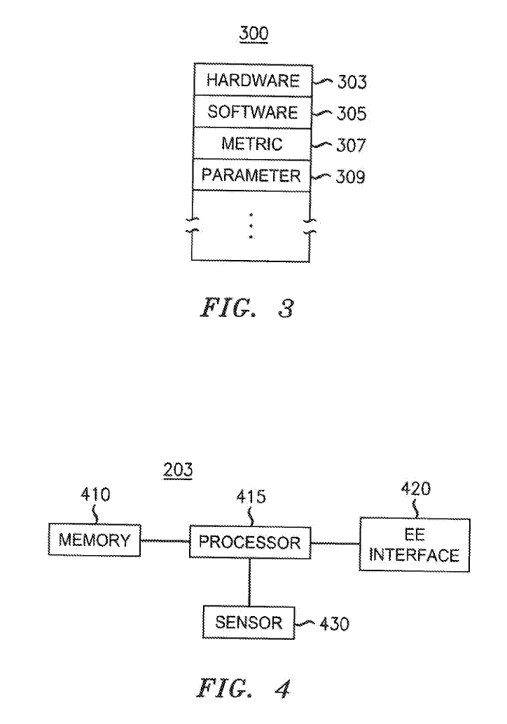

FIG. 3 illustrates various fields of a representative profile 300 of an MS. As shown in FIG. 3, profile 300 includes, e.g., hardware field 303 which specifies the hardware of the MS, e.g., its make and model number; software field 305 which specifies the software in the MS, e.g., the current version number of its firmware; metric field 307 which specifies a data format of a metric measured by the MS, e.g., ° F. for environmental temperature, % for relative humidity, and latitude and longitude (degrees, minutes and seconds) for location; parameter field 309 which identifies run-time parameters in the MS's firmware which are adjustable by FE 205 to modify the MS's operation in real time; etc.

Referring back to FIG. 2, EE 205 collects data from registered MSs via MS interface 217, which includes appropriate data drivers and signal transceivers for communications with the MSs in accordance with a pre-agreed protocol(s). The collected data is stored in database 215 in memory 210 in association with the IDs of the respective MSs from which the data is received. In this instance, EE 205 collected in database 215 from MS2 relative humidity data (70%), from MS5 temperature data (70° F.), from MS7 location data (38° 53′23″N, 77° 00′27″W), etc. Controller 220 may clean and filter the collected data in database 215 before it is forwarded via server interface 225 to network server 107 for further processing. Server interface 225 includes an appropriate data driver for communications with network server 107 in accordance with a pre-agreed protocol.

Controller 220 in EE 205 is also programmed to initiate data-reporting from individual registered MSs. In one embodiment, to minimize the amount of traffic over the air, controller 220 requests only a subset of the registered MSs to report data relevant at that time. Controller 220 may also adjust the values of run-time parameters identified in the parameter field of the registered MSs' profiles in table 213 to manipulate the operation and behavior of the MSs. For example, controller 220 may set values for such run-time parameters as to specify how often an MS should report, what level of transmission power an MS should use, etc.

FIG. 4 illustrates an MS in one embodiment, which is denoted 407 and representative of each MS 103. MS 407 has memory 410 for storing, among other things, firmware including run-time parameters. Instructed by the firmware, processor 415 carries out the operation of MS 407, including generating data using sensor 430 therein, which may be a thermo-sensor for measuring temperatures, a humidity-sensor for measuring relative humidity, a GPS sensor for receiving signals from GPS satellites, etc. For example, processor 415 generates location data by determining the current location of MS 407 based on the received GPS signals. Processor 415 also assembles the data as generated in an appropriate format for transmission. In addition, processor 415 may receive from time to time through EE interface 420, compatible with MS interface 217 described above, a control signal containing new run-time parameter values. For example, to save power consumption of MS 407, one such parameter value may specify a chirp/ping period at which MS 407 reports data. Another parameter value may specify the transmission power level of MS 407.

FIG. 5 illustrates network server 107 in one embodiment, which includes memory 503, network controller SOS and interface 509. As shown in FIG. 5, memory 503 stores therein MS registry 521, which in this instance includes (N+1) registration tables. N of these registration tables are associated with EEs 105-1 through -N, respectively. Like above-described registration table 213 included in an EE, each of the N registration tables in registry 521 contains IDs of the MSs registered with the associated EE, and their respective profiles. In fact, in the steady state the respective registration tables 213 in EEs 105-1 through -N are duplicative of these N registration tables in registry 521. It is important to note that because network controller 505 has access to such N registration tables, it can control each EE 105, e.g., to store MS firmware, take a particular MS out of service, etc. Thus, together with EEs 105, controller 505 effects a 2-tier control system.

The remaining table in registry 521, referred to as a “new-MS table,” contains IDs of new MSs to be deployed in the field, and their respective profiles. These new MSs, although registered with network server 107, are not registered with any of EEs 105.

With registry 521, network controller 505 is capable of tracking migration of an MS from one EE's communication coverage to another, and registering an MS with a new EE. For example, when an MS, say, MS 103-5 first comes within the communication coverage of an EE, say, EE 105-5, it receives signals from MS 103-5 containing data reports, along with its MS ID. When EE 105-5 while attempting to collect the data from the reports determines that database 215 therein does not contain the received MS ID, it concludes that this is the first time it receives data reports from MS 103-5. By checking its registration table 213 which also does not contain the received MS ID, EE 105-5 further concludes that MS 103-5 is not registered therewith. EE 105-5 then sends an MS registration request, including its EE ID and the received MS ID, to network server 107. After receiving one such request, network controller 505 checks the received MS ID against the IDs in the new-MS table in registry 521. If the received MS ID matches one of the IDs in the table, controller 505 determines that MS 103-5 is newly deployed. In response to the registration request, controller 505 sends via interface 509 to EE 105-5 the MS ID in question, along with the associated profile from the new-MS table. At the same time, controller 505 creates a new entry, containing the MS ID in question and associated profile, in the registration table associated with EE 105-5 in registry 521, and removes the corresponding entry from the new-MS table.

Otherwise, if the received MS ID does not match any of the IDs in the new-MS table, controller 505 goes on to check the received MS ID against the IDs in those registration tables in registry 521 which are associated with EEs 105 other than EE 105-5. When controller 505 finds an ID match in a particular registration table in registry 521, which is associated with, say, EE 105-18, controller 505 sends via interface 509 to EE 105-5 the MS ID in question, along with the associated profile from that particular registration table, and adds the same information to the registration table associated with EE 105-5 in registry 521, thereby registering MS 103-5 with EE 105-5. At the same time, controller 505 removes the corresponding information from the particular registration table, and sends a request to EE 105-18 to remove the same information from its registration table 213, thereby realizing dc-registration of MS 103-5 with EE 105-18.

After EE 105-5 receives from network controller 505 the ID of MS 103-5 and the associated profile, it enters the received information in its registration table 213, thereby completing its registration of MS 103-5, and starts collecting in its database 215 data from MS 103-5.

Memory 503 in network server 107 also stores the latest versions of firmware denoted 523 for different types of ME in system 100, and control rules 525 set by an operator of system 100, etc. Network controller 505 communicates via interface 509 to EEs 105 instructions for their operation according to control rules 525. For example, these instructions may specify the priority of certain data collections by EEs 105 over the others, and coordination of data transmissions from EEs 105 to server 107, which affects the pattern and volume of incoming traffic to server 107. Application protocols, such as AtomPub, may be adopted for such communications by network controller 505 to individual EEs 105. In addition, when an upgrade of a certain type of MS firmware is due, network controller 503 identifies from the registration tables in registry 521 those EEs with which one or more MSs are registered, which run the certain type of firmware. Network controller 505 causes a new version of the firmware in question to be downloaded from memory 503 to the identified EEs, along with information specifying the certain type of firmware to be upgraded. In response, controller 220 of each identified EE checks the profiles of the registered MSs within its communication coverage to identify those MSs running the certain type of firmware. Controller 220 contacts the identified MSs and delivers the new firmware version to the same, thereby realizing their firmware upgrade.

With the arrangement of system 100, controller 220 in an EE 105 is in a position to mix and match data coming from multiple MSs within its communication coverage to preprocess the data. Controller 220 may also be programmed in accordance with control rules 525 to dynamically make local decisions in response to the instant behavior of an MS, which may affect the operation of another MS and/or EE. In one illustrative embodiment, system 100 is implemented in a hospital having different rooms and hallways. EEs 105 of system 100 are distributed among such rooms and portions of hallways, respectively. By way of example, but not limitation, the communication coverage of each EE 105 in this instance approximately coincides with the room or the portion of a hallway the EE 105 is in, which may overlap the communication coverage of another FE 105 at its boundary. Let's assume in this example that EE 105-1 has communication coverage of Room A, and EE 105-2 has communication coverage of Room B, which adjoins Room A. Further, two types of MS are used to track patients' movements in the hospital. The first type of MS, referred to as a “location MS,” may be in the form of a wrist-band for attachment to a patent, which transmits data concerning its current location and, thus, the patent's current location. The second type of MS, referred to as a “video MS,” may comprise a video camera, which transmits images of its surroundings and, in particular, patients.

Continuing with the example, a location MS, say, MS 103-10 is attached to a particular patient assigned to room A to track his/her movement. Video MSs, say, MS 103-21 and MS 103-25, are deployed in room A to provide images of the patient in Room A. In this instance, MSs 103-21 and -25 may be installed in opposite corners of Room A to cover each other's blind spots. Besides MSs 103-21 and -25, MS 103-10 currently is located in room A, all of which are within the communication coverage of EE 105-1. Furthermore, MSs 103-10, -21 and -25 currently are registered with EE 105-1, which has their respective profiles in its registration table 213. In addition, EE 105 has been collecting in its database 215 location data from MS 103-10, and video data from MSs 103-21 and -25.

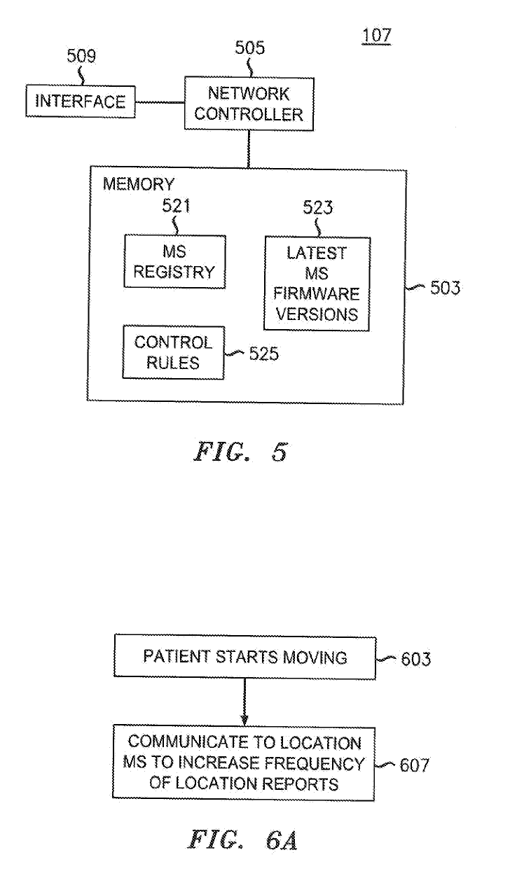

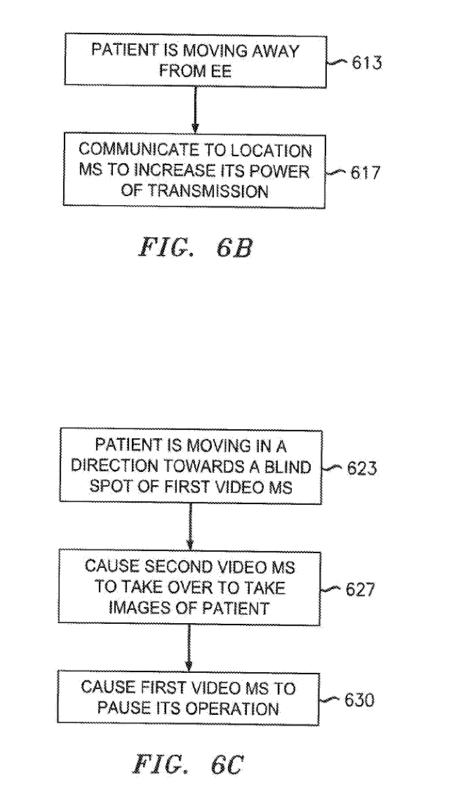

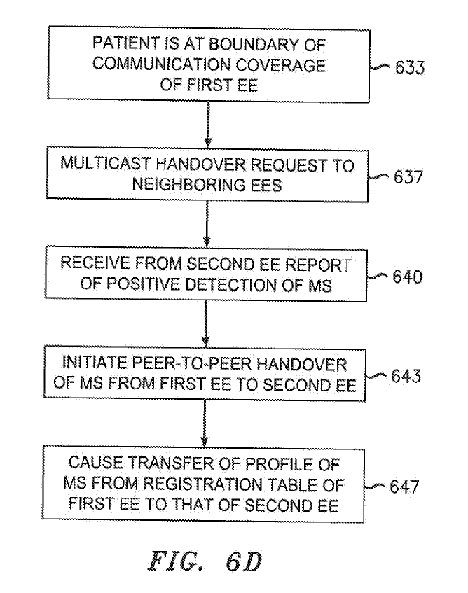

Again, by way of example, the particular patient initially is at rest in Room A. Referring to FIG. 6A, when controller 220 of EE 105-1 at step 603 determines that the patient starts moving because of different locations reported by location MS 103-10 in successive reports, controller 220 at step 607 communicates to location MS 103-10 to increase the frequency of its location reports, which is a run-time parameter in this embodiment, to better track the patient's movement. Controller 220 may increase such a location report frequency with the speed of the patient's movement. The latter may be determined by computing the displacement of location MS 103-10 during a report period divided by the length of that report period.

Referring to FIG. 6B, when controller 220 of EE 105-1 at step 613 determines that the patient is moving away from EE 105-1 by comparing the current location of MS 103-10 with its last location, controller 220 at step 617 communicates to location MS 103-10 to increase its power of transmission of location reports, which is another run-time parameter in this embodiment, to better reception by controller 220 of the reports. For example, the transmission power level required of MS 103-10, which may be discrete, may increase with the distance of MS 103-10 from EE 105-1, which controller 220 may determine based on the current location of MS 103-1 relative to the fixed location of EE 105-1.

Referring to FIG. 6C, when controller 220 of EE 105-1 at step 623 determines that the patient is moving in a direction towards a blind spot of a first video MS, say MS 103-21, currently taking images of the patient, which direction may be determined based on the locations reported by location MS 103-10 in successive reports, controller 220 at step 627 causes a second video MS in room A, i.e., MS 103-25 in this instance, to take over to start taking images of the patient. At step 630, controller 220 causes the first video ME to pause its operation.

In another instance, the patient is about to exit Room A and enter Room B. Referring to FIG. 6D, controller 220 in that instance determines at step 633 that the patient is at the boundary of the communication coverage of EE 105-1 because of weak reception of reports from MS 103-10, despite the maximum transmission power level required thereof. Controller 220 at step 637 multicasts a handover request to neighboring EEs 105 in the rooms adjacent to Room A, which include EE 105-2 in Room B. This handover request, which includes the ID, and last reported location, of MS 103-10, is intended to hand over the control and administration of MS 103-10, and the responsibility of video tracking of the patient to another EE 105. In this instance, as the patent leaves Room A for Room B, EE 105-2 starts to receive from MS 103-10 signals containing its ID, and determines that MS 103-10 comes within its communication coverage. After matching the received ID with the ID of MS 103-10 in the handover request, EE 105-2 reports to EE 105-1 positive detection of MS 103-10. After controller 220 at step 640 receives from EE 105-2 the report of the positive detection of MS 103-10, it at step 643 initiates a peer-to-peer handover of MS 103-10 from EE 105-1 to EE 105-2. Specifically, controller 220 at step 647 causes a transfer of the profile of MS 103-10 from the registration table (denoted 213 generically) of EE 105-1 to that of EE 105-2, thereby registering MS 103-10 with EE 105-2 and de-registering the same with EE 105-1. It should be noted that such a peer-to-peer handover does not involve network server 107, which is only informed by controller 220 after the fact so that server 107 can update the registration tables in MS registry 521 associated with EE 105-1 and EE 105-2, respectively to reflect the registration and de-registration of MS 103-10 therewith as a result of the handover.

In addition, through the handover request, controller 220 of EE 105-1 also causes EE 105-2 to direct a video MS in Room B within its communication coverage to start taking images in the direction of the last reported location of MS 103-10 which, as mentioned before, is included in the request. Taking over the previous responsibilities of EE 105-1, EE 105-2 starts collecting data from both MS 103-10 and the video MS in Room B to continue to monitor the patient.

The foregoing merely illustrates the principles of the invention. It will thus be appreciated that those skilled in the art will be able to devise numerous arrangements which embody the principles of the invention and are thus within its spirit and scope.

For example, in the disclosed embodiment of generic EE 205, registration table 213 and database 215 are described as two separate data structures. However, it will be appreciated that a person skilled in the art may merge table 213 with database 215 to become a single data structure.

It will also be appreciated that a person skilled in the art may secure the communications between the EEs and MSs for fear of illegitimate manipulations of their operations.

Finally, although system 100, as disclosed, is embodied in the form of various discrete functional blocks, such a system could equally well be embodied in an arrangement in which the functions of any one or more of those blocks or indeed, all of the functions thereof, are realized, for example, by one or more processors or devices.

What is claimed is:

1. An apparatus for use in a sensor system, comprising:
a memory for storing an identification of at least one mobile sensor, and information concerning a parameter in association with the identification of the mobile sensor;
a first interface for receiving data from the mobile sensor operating based on a first value of the parameter in the mobile sensor;
a second interface for sending information, derivable from the data, to a server for processing the information; and
a controller configured to cause the first value of the parameter in the mobile sensor to be changed to a second value, thereby affecting an operation of the mobile sensor.

2. The apparatus of claim 1 wherein the data concerns an environmental condition.

3. The apparatus of claim 1 wherein the data concerns a position of the mobile sensor.

4. The apparatus of claim 1 wherein the parameter concerns a frequency of data reports by the mobile sensor.

5. The apparatus of claim 4 wherein the second value of the parameter corresponds to a higher frequency of the data reports than the first value after it is determined that a speed of motion of the mobile sensor has increased.

6. The apparatus of claim 1 wherein the parameter concerns power of transmission of data reports by the mobile sensor.

7. The apparatus of claim 6 wherein the second value of the parameter corresponds to a higher level of the power of transmission than the first value after it is determined that a distance of the mobile sensor from the apparatus has increased.

8. An apparatus for use in a sensor network, comprising:
a memory for storing an identification of at least one mobile sensor and, in association with the identification, information concerning selected software executable on the mobile sensor;
a first interface for receiving data from the mobile sensor having the selected software therein;
a second interface for receiving from a server a request for upgrading the selected software and code for upgrading the selected software; and
a controller configured to retrieve from the memory the identification of the mobile sensor in response to the request, and to send the received code to the mobile sensor identified by the retrieved identification for upgrading the selected software therein.

9. The apparatus of claim 8 wherein the selected software includes firmware of the mobile sensor.

10. The apparatus of claim 8 wherein the information includes an identification of a version of the selected software.

11. The apparatus of claim 8 wherein the data concerns an environmental condition.

12. The apparatus of claim 8 wherein the data concerns a position of the mobile sensor.

13. The apparatus of claim 12 wherein the mobile sensor includes a mobile tag.

14. A method for use in a certain apparatus in a sensor system, comprising:
receiving data from a mobile sensor associated with the certain apparatus;
determining that the mobile sensor is about to leave communication coverage of the certain apparatus;
communicating to other apparatuses in the sensor system an identification of the mobile sensor;
receiving from a selected one of the other apparatuses information concerning detection of the mobile sensor within communication coverage of the selected apparatus; and
dissociating the mobile sensor from the certain apparatus.

15. The method of claim 14 wherein the communication coverage of the certain apparatus is a function of strength of signals containing the data received from the mobile sensor.

16. The method of claim 14 wherein the other apparatuses are neighboring to the certain apparatus.

17. The method of claim 14 further comprising sending a profile of the mobile sensor in the certain apparatus to the selected apparatus.

18. The method of claim 17 wherein the profile includes information concerning a parameter in the mobile element which affects an operation of the mobile element.

19. The method of claim 17 wherein the profile includes information concerning software executable on the mobile element.

20. The method of claim 14 further comprising causing the selected apparatus to initiate an action by a second mobile element associated with the selected apparatus.
